(19) United States
(12) Patent Application Publication
(10) Pub. No.: US 2004/0072085 A1
(43) Pub. Date: Apr. 15, 2004

(54) Method of providing durable, matte images on stone and masonry

(76) Inventors: John Walter Horne, Provo, UT (US); George Evan Bybee, Orem, UT (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/271,213

(22) Filed: Oct. 15, 2002

(51) Int. Cl. B32B 27/00; B32B 27/14; B41M 3/12

(52) U.S. Cl. 430/9; 430/330; 430/324; 428/914; 428/423.1; 428/913; 428/500; 428/417

(57) ABSTRACT

A method for rendering durable, matte-finish images on a stone or masonry substrate, comprising: providing a stone or masonry substrate presenting a substantially flat image-receiving surface or otherwise shaped to accept an image, the image-receiving surface having a specular reflectivity suitable for accepting an image; applying a polymer to the image-receiving surface and curing the polymer thereto, the polymer being characterized by an avoidance of coloration or discoloration over time and a degree of clarity sufficient that the specular reflectivity of the image-receiving surface of the stone or masonry substrate is substantially unaltered, and the natural appearance thereof substantially unchanged, after cure of the polymer thereto, the polymer further being characterized by a cure hardness such that a transferable sublimable ink image carried on the image-receiving surface after transfer of the image into the cured polymer, is not eroded from the image-accepting surface by effects of weather, wear, abrasion or UV radiation, but erodes at a same rate as the image-receiving surface; providing a transferable sublimable ink image on an image transfer substrate suitable for transfer of the image to the stone or masonry substrate; and applying the image transfer substrate carrying the transferable sublimable ink image to the cured polymer and transferring the image thereinto via sublimation; such that the image becomes substantially fused to the image-receiving surface of the substrate, the image-receiving surface of the substrate retaining a natural, matte appearance following transfer of the image, and the transferred image being durable and resistant to abrasion, wear and the effects of weather and UV radiation. Preferably, the polymer is a polymer manufactured by PPG Industries and identified as Flexed ‘N’ Flat™ (DCU 2060).

### FIELD OF THE INVENTION

The present invention relates to ink sublimation processes, and more particularly to novel systems and methods for transferring sublimable dye or ink images into polymer-treated stone and masonry, resulting in durable, ultra-violet protected, matte images thereon.

### BACKGROUND OF THE INVENTION

Ink sublimation techniques are well known in the printing industry. Ink sublimation refers to processes by which specialized inks (known as sublimable inks) are forced by pressure or other means into the open pores of a heated polymer. Once the polymer is cooled, the pores close leaving the ink fused or amalgamated into the polymer. Ink sublimation processes result in durable, scratch-resistant prints, since the ink is projected from within the polymerized material. In effect, the polymer is “tattooed” with ink. Printing with ink sublimation techniques has been achieved or attempted on a variety of materials, including without exception glass, metal, wood, plastics, stone, ceramic, composites and textiles by first adhering an appropriate polymer to the surface of the substrate and then sublimating the sublimable inks/dyes thereto to produce an image.

Ink sublimation processes in connection with stone, brick, concrete or masonry give rise to several issues. Polymers generally used in the masonry industry are sealants, giving stone a lacquered/varnished look, rendering the appearance of the stone unnatural. None of the polymers is suitable for maintaining the stone or masonry in a natural-appearing state while accepting an image. In addition, the applied polymers, traditionally applicable to stone may insufficiently penetrate the surface thereof, thereby providing an insufficient level of durability. As a consequence, ink sublimation prints using traditional masonry polymers may reside only superficially on the stone's surface, and thus be subject to more rapid wear and/or damage (i.e., scraping). Indeed, using traditional masonry polymers, the sublimable ink image and the polymer may more easily be worn or scraped away.

Images may be applied to a variety of items and surfaces to increase their artistic appeal and appearance. Images intended for mere viewing or used in accordance with applications subjected to light may nor require substantial durability. However, certain stone and masonry applications that endure frequent wear or cleaning, or are exposed to weather or prolonged sunlight (in particular UV radiation), require particular methods and materials to print durable images that can withstand the effects of sustained and significant use and exposure to the elements. Such applications include, without exception, countertops, flooring, furniture, walls, steps, monuments, tombstones, statues, handrails, bathtubs, and the like. Traditional masonry polymers are insufficient in this regard, as they do not penetrate the surface of the stone/masonry substrate, nor do they embed the transferred image into the face of the substrate. As a result, the image and polymer may easily be worn from the substrate surface, whether by use or by exposure to prolonged sunlight or weather, thereby providing an unacceptable level of durability. Additionally, masonry polymers tend to color or discolor immediately or over time, and further may alter the specular reflectivity of the substrate, or may lack sufficient clarity, thereby providing an undesirable sheen or gloss to the treated substrate. Other general masonry polymers are unable to accept a sublimable ink image with satisfactory quality.

What is needed is a method for transferring sublimable ink or dye images to stone or masonry materials, where the stone/masonry materials retain their natural appearance after transfer, and where the transferred image is sufficiently durable to preclude its being worn from the surface of the stone/masonry materials as a result of exposure to wear, weather, or UV radiation, the transferred images wearing only at the same rate as the stone or masonry surface.

Accordingly, the present invention provides a method for transferring sublimable ink or dye images to stone or masonry materials, where the stone/masonry materials retain their natural appearance after transfer, and where the transferred image is sufficiently durable to preclude its being worn from the surface of the stone/masonry materials as a result of exposure to wear, weather, or UV radiation, the transferred images wearing only at the same rate as the stone or masonry surface.

### SUMMARY OF THE INVENTION

The present invention provides a method for rendering durable, matte-finish images on a stone or masonry substrate, comprising: providing a stone or masonry substrate presenting a substantially flat image-receiving surface or otherwise shaped to accept an image, where the image-receiving surface has a specular reflectivity suitable for accepting an image; applying a polymer to the image-receiving surface and curing the polymer thereto; providing a transferable sublimable ink image on an image transfer substrate suitable for transfer of the image to the stone or masonry substrate; and applying the image transfer substrate carrying the transferable sublimable ink image to the cured polymer and transferring the image thereinto via sublimation, such that the transferable sublimable ink image migrates into and becomes substantially fused to the image-receiving surface of the substrate and embedded therein, the image-receiving surface of the substrate retaining a natural, matte appearance following transfer of the image, and the transferred sublimable ink image being durable and resistant to abrasion, wear and the effects of weather and UV radiation.

The polymer is characterized by an avoidance of coloration or discoloration over time and a degree of clarity sufficient that the specular reflectivity of the image-receiving surface is substantially unaltered, and the natural appearance thereof substantially unchanged, after cure of the polymer thereto. The polymer further has a cure hardness such that a transferable sublimable ink image carried on the image-receiving surface after transfer of the image into the cured polymer, is not eroded from the image-accepting surface by effects of weather, wear, abrasion or UV radiation, but erodes at a same rate as the image-receiving surface

In a preferred embodiment, the polymer is polymer manufactured by PPG Industries and identified as Flexed ‘N’ Flat™ (DCU 2060).

The present invention also provides a method for rendering durable, matte-finish images on a stone or masonry substrate via use of the polymer identified as Flexed ‘N’ Flat™ (DCU 2060) and manufactured by PPG Industries, comprising: providing a stone or masonry substrate presenting a substantially flat image-receiving surface or otherwise shaped to accept an image, the image-receiving surface having a specular reflectivity suitable for accepting an image; applying the PPG polymer to the substrate and curing the polymer thereto; providing a transferable sublimable ink image on an image transfer substrate suitable for transfer of the image to the stone or masonry substrate; and applying the image transfer substrate carrying the transferable sublimable ink image to the cured polymer and transferring the image thereinto via sublimation, such that the transferable sublimable ink image migrates into and becomes substantially fused to the image-receiving surface of the substrate and embedded therein, the image-receiving surface of the substrate retaining a natural, matte appearance following transfer of the image, and the transferred sublimable ink image being durable and resistant to abrasion, wear and the effects of weather and UV radiation.

The polymer may penetrate the image-receiving surface, or may overlay and adhere to same. Additionally, transfer of the image may include receiving the image onto the image-receiving surface of the substrate. The substrate may be stone, brick, ceramic, concrete or asphalt.

### BRIEF DESCRIPTION OF THE DRAWING

FIG. 1 is a perspective view of an ink substrate, polymer, and stone/masonry layer in accordance with the present invention.

FIG. 2 is a perspective view of an ink substrate and polymer applied to a stone/masonry layer in accordance with the present invention.

FIG. 3 is a perspective cross-sectional view of sublimable ink and polymer penetration into the stone/masonry layer.

FIG. 4 is a flow chart of a preferred embodiment of the method of providing a durable, matte image on a stone/masonry substrate, in accordance with the present invention.

FIG. 5 is a flow chart of a further embodiment of the method of providing a durable, matte image on a stone/masonry substrate, in accordance with the present invention.

### DETAILED DESCRIPTION OF THE INVENTION

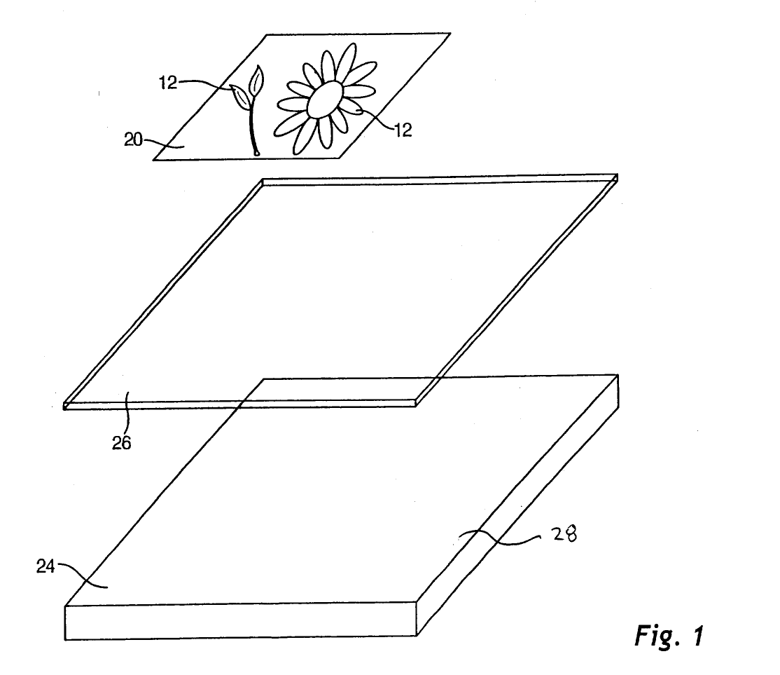

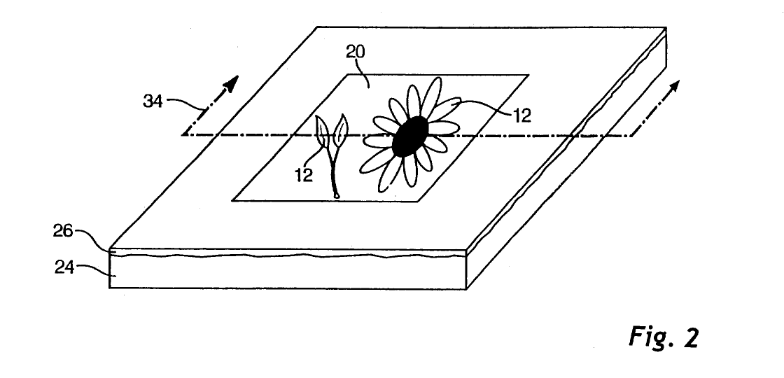

Turning to the FIG. 1, the method of providing a durable, matte image on a stone or masonry substrate comprises the following steps: a stone or masonry substrate 24 is provided having a substantially flat image-receiving surface 28 or otherwise being shaped to accept an image, the image-receiving surface 28 having a specular reflectivity suitable for accepting an image; a polymer 26 is applied to the image-receiving surface 28 and cured thereto; and a transferable sublimable ink image 12 is applied to the cured polymer 26 and transferred thereinto via sublimation. The transferable sublimable ink image 12, which has been prepared initially on an image transfer substrate 20 suitable for transfer of the image 12 to the stone or masonry substrate 24, as illustrated in FIGS. 1-2, migrates into and becomes substantially fused to the image-receiving surface 28 of the substrate 24 and embedded therein, the image-receiving surface 28 of the substrate 24 retaining a natural, matte appearance following transfer of the image 12, and the transferred image 12 being durable and resistant to abrasion, wear and the effects of weather and UV radiation.

The polymer 26 is characterized by an avoidance of coloration or discoloration over time and a degree of clarity sufficient that the specular reflectivity of the image-receiving surface 28 of the stone or masonry substrate 24 is substantially unaltered, and the natural appearance thereof substantially unchanged, after cure of the polymer 26 thereto. The polymer 26 further is characterized by a cure hardness such that a transferable sublimable ink image 12 carried on the image-receiving surface 28 after transfer of the image 12 into the cured polymer 26, is not eroded from the image-accepting surface 28 by effects of weather, wear, abrasion or UV radiation, but erodes at a same rate as the image-receiving surface 28.

During cure, the polymer 26 may penetrate the image-receiving surface 28 or may overlay and adhere to same. Similarly, the transferred sublimable ink image 12 may be received on the image-receiving surface 28 of the stone/masonry substrate 24.

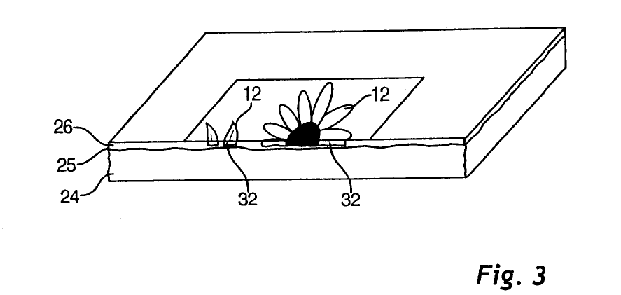

FIG. 3 shows the penetration 32 of the polymer 26 and sublimable ink image 12 into the substrate 24. Depth of penetration 25 is dependent primarily on the characteristics of the stone/masonry substrate 24. Using a polymer with the above-described properties, an average depth of penetration of 2-4 mm may be achieved. The substrate 24 can be any stone or masonry product, including without limitation stone, brick, ceramic, concrete, terra cotta, terrazzo, pavement, asphalt, and similar.

As noted, polymers 26 generally used in the masonry industry tend to destroy the natural appearance of the stone/masonry substrate 24, giving it a lacquered/varnished/glossy appearance. In addition, masonry industry polymers 26 do not sufficiently penetrate the surface 28 of the masonry/stone substrate 24, so that any coverage thereof is merely superficial. As a result, ink images 12 sublimated to polymer 26 coated stone surfaces 28 may provide insufficient durability and be worn therefrom. This problem is exacerbated in common stone/masonry applications such as walkways, countertops, handrails, bathtub rails, and the like, which may receive a great deal of use/wear.

By contrast, certain polymers 26 used in the automotive refinish industry, provide the aforementioned qualities when used in ink sublimation processes on stone/masonry, viz, durability of image, including resistance to wear, abrasion and weather effects (including UV radiation); non-coloration/discoloration immediately or over time; sufficient clarity such that the specular reflectivity of the substrate 24 is substantially unaltered; and ability to accept a sublimable ink image 12 with satisfactory quality. Similar polymers 26 used in other industries may also exhibit similar characteristics in ink sublimation, as the result of a similar chemical formula. The ink sublimation process in accordance with the present invention is intended to include all polymers 26 exhibiting similar properties. That is, suitable polymers 26 in accordance with the invention are those capable of embedding into and adhering to substrates and accepting sublimable ink images thereto, while leaving the color, specular reflectivity and clarity of the substrate material 24 substantially unaltered.

Color of a substrate material 24 refers the light frequencies that are filtered, emitted or absorbed by the material from natural white light. Clarity refers to the percentage of light incident on the material that is transmitted therethrough. Specular reflectivity refers to the percentage of light incident on a material that is reflected from the material. Accordingly, suitable polymers 26 for use in connection with the present invention are those which, when adhered to or absorbed by the surface of a substrate material, render the portion of the substrate surface covered by polymer visually indistinguishable from the surface of the substrate, itself.

As a specific preferred polymer 26, the polymer identified as Flexed “N” Flat™ (DCU 2060), produced by PPG Industries, Inc. of Strongsville, Ohio, may be used in ink sublimation processes in accordance with the present invention, to maintain the natural appearance of the stone or masonry substrate 24 and provide excellent adhesion of the transferred sublimable ink image 12 thereto. The PPG DCU 2060 polymer, used primarily in automobile refinish coating as a pre-flattened, pre-flexed clear to achieve desired increased gloss levels, also cures hard, thereby providing a highly durable surface. The polymer also provides superior UV protection, weather-resistance and wear-resistance, and leaves a generally imperceptible matte finish on the surface of the stone/polymer substrate. Accordingly, the polymer is especially suited for use in outdoor environments.

The PPG DCU 2060 polymer thus possesses the unique characteristics described hereinbefore and, when coated onto/penetrating into a stone/masonry substrate 24, will properly accept a sublimated ink/due image 12, where other masonry polymers will not. Also, sublimable inks 12 lack good UV protection and matte finish qualities, necessary for maintaining the natural appearance of the stone or masonry substrate 24. As noted, these characteristics are provided by the PPG DCU 2060 polymer.

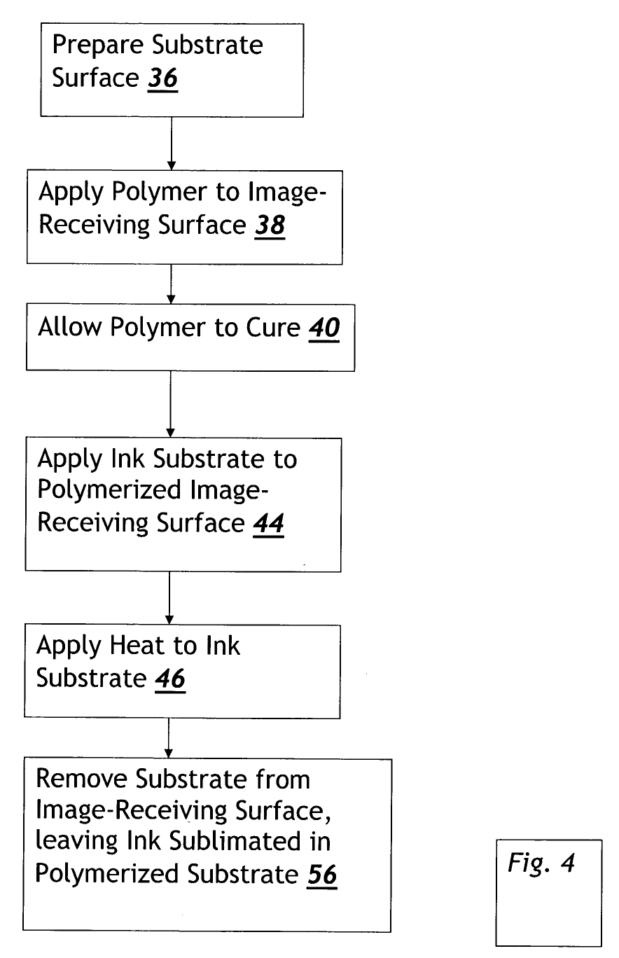

FIG. 4 illustrates the preferred method for providing a durable, matte image on a stone or masonry substrate in accordance with the present invention. In a first step 36, the stone/masonry substrate is prepared by cleaning to remove dust, particles, oil and other residue from the surface thereof, thereby maximizing the bonding of the polymer thereto. Where desired, the image-receiving surface of the stone or masonry substrate may be polished, etched or textured, or similarly treated, to give rise to a desired finish.

Once the image-receiving surface is prepared, the polymer, preferably the PPG DCU 2060 polymer, is applied 38 thereto using any conventional means, including without limitation brushing, dipping, hot-melting, solvent-bonding, wiping, spraying, and the like. Preferably, the polymer is applied 38 via spraying. The polymer is applied 38 in sufficient volume and for a sufficient duration to permit the polymer to penetrate the image-receiving surface of the substrate. Alternatively, the polymer may rest on the image-receiving surface of the substrate and adhere thereto, without penetrating same. Still further alternatively, the polymer may be completely absorbed by the substrate, leaving only a thin layer of polymer on the image-receiving surface. In such cases, sublimable ink images sublimated into the polymer may penetrate beyond the surface of the substrate, creating an image fused into the substrate and not easily removed or worn therefrom.

Penetration of the polymer into the substrate occurs immediately upon application 38. Additional polymer may be applied after 2 hours. The polymer must extend above the image-receiving surface by at least 2 mm in order to provide adequate UV and other protection.

After the polymer is applied 38 to the image-receiving surface, it is cured 40 by any suitable conventional method, including without exception, drying, hardening, absorbing, and reacting with a chemical catalyst. A full cure is obtained generally after 24 hours.

After the polymer is fully cured 40 onto the stone/masonry substrate, the sublimable ink image, already prepared on an ink transfer substrate 42, is applied 44 to the polymer-coated stone/masonry surface and the sublimable ink image is transferred into the polymer via sublimation 46. Sublimation processes 46, by which sublimable inks are converted directly to gases for transfer into a polymer or substrate, are known, and any conventional suitable ink sublimation process, including without limitation, hot air transfer, may be used in accordance with the present invention. As an example in accordance with the present invention, sublimation via heat transfer may involve the use of a heat press at a temperature ranging from 150-450 degrees F. and preferably 400 degrees F., for a duration of from 1 second to 2 minutes, depending on the utilized polymer and substrate. Preferably, when using the PPG DCU 2060 polymer, heat of 400 degrees F. is applied for 30 seconds.

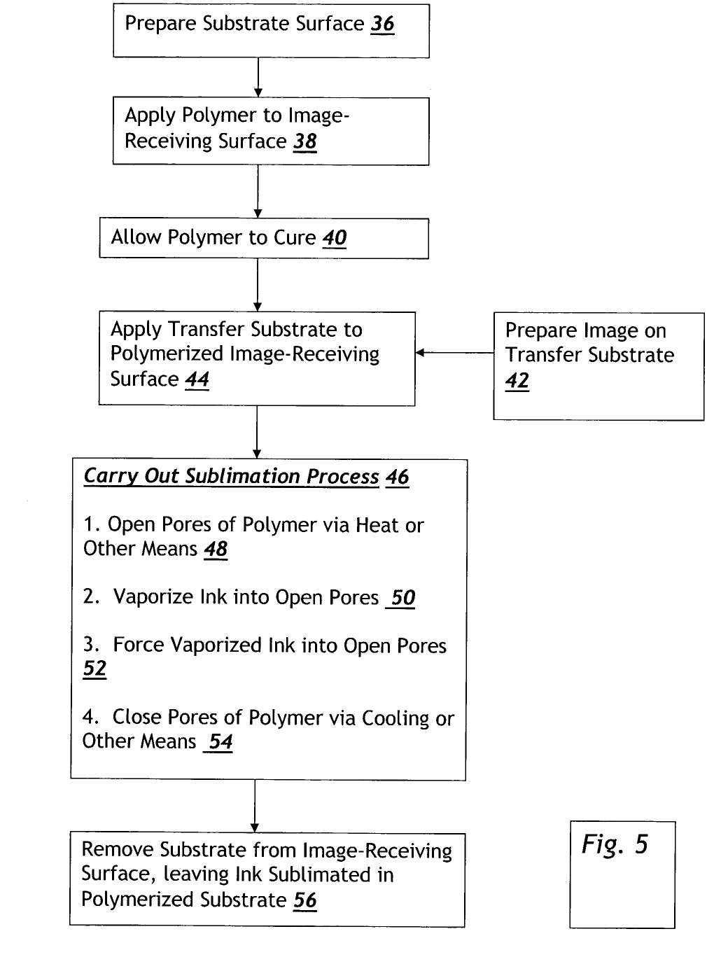

As illustrated in FIGS. 4-5, sublimation preferably occurs via an application of heat 46 to the ink transfer substrate, thereby opening the pores of the polymer 48, or alternatively liquefying the polymer, in order to facilitate fusing/amalgamation of the sublimable ink image into the polymer material. Applied heat softens polymer, allowing the sublimable ink (now a gas) to enter pores and become part of the polymer. In some cases, pressure may also be applied to force the sublimable ink image into the polymer material. Applied pressure effectively guarantees the direction of image transfer, pushing against polymer. The pores of the polymer are cooled after the image transfer, by cooling or other means 54.

After the polymer is cooled, the transfer substrate is removed 56, leaving the sublimable ink image amalgamated into the polymer. As such, the amalgamated sublimable ink image is protected from abrasion and other wear, as well as the elements, including UV damage. Alternatively, the image may be recoated with polymer after sublimation and cooling, to provide additional protection for the image. Because of the properties of the PPG DCU 2060 polymer, the surface of the stone/masonry substrate appears matte, or natural, with the concomitant effect that the image appears to emanate from within the substrate or be “tattooed” thereon.

In certain embodiments, the polymer may penetrate the substrate surface such that the sublimable ink image, in penetrating the polymer, becomes embedded in the substrate itself. In other embodiments, the polymer may overlay the substrate and adhere thereto, receiving the sublimable ink image on the surface of the substrate while maintaining the natural appearance thereof. The polymer effectively fills any voids or irregularities and variations in the substrate surface, further facilitating penetration of the sublimable ink image into the substrate and providing improved adhesion of the polymer to the substrate.

FIGS. 2 and 3 show a cross-sectional view, illustrating the penetration of both the polymer 26 and the sublimable ink image 12 into the image-receiving surface 28 of the stone/polymer substrate 24. Because of the porous and inconsistent nature of some stone, the depth of penetration of the polymer 26 into the stone 24 may vary. Nevertheless, an average depth of penetration of approximately 2-4 mm may be achieved across the stone surface 28.

While the invention has been described with respect to certain specific embodiments, it will be appreciated that many modifications and changes may be made by those skilled in the art without departing from the invention. It is intended, therefore, by the appended claims to cover all such modifications and changes as may all within the true spirit and scope of the invention.

What is claimed is:

1. A method for rendering durable, matte-finish images on a stone or masonry substrate, comprising:
providing a stone or masonry substrate, where the substrate presents a substantially flat image-receiving surface or is otherwise shaped to accept an image, and where the image-receiving surface has a specular reflectivity suitable for accepting an image;
applying a polymer to the image-receiving surface and curing the applied polymer thereto, the polymer being characterized by an avoidance of coloration or discoloration over time and a degree of clarity sufficient that the specular reflectivity of the image-receiving surface of the stone or masonry substrate is substantially unaltered, and the natural appearance thereof substantially unchanged, after cure of the polymer thereto, the polymer further being characterized by a cure hardness such that a transferable sublimable ink image carried on the image-receiving surface after transfer of the image into the cured polymer, is not eroded from the image-accepting surface by effects of weather, wear, abrasion or UV radiation, but erodes at a same rate as the image-receiving surface;
providing a transferable sublimable ink image on an image transfer substrate suitable for transfer of the image to the stone or masonry substrate; and
applying the image transfer substrate carrying the transferable sublimable ink image to the cured polymer and transferring the image into the cured polymer via sublimation;
such that the transferable sublimable ink image migrates into and becomes substantially fused to the image-receiving surface of the substrate and embedded therein, the image-receiving surface of the substrate retaining a natural, matte appearance following transfer of the image, and the transferred sublimable ink image being durable and resistant to abrasion, wear and the effects of weather and UV radiation.

2. The method of claim 1, wherein the polymer is a polymer manufactured by PPG Industries and identified as Flexed ‘N’ Flat™ (DCU 2060).

3. A method for rendering durable, matte-finish images on a stone or masonry substrate via use of a specific polymer, namely the polymer identified as Flexed ‘N’ Flat™ (DCU 2060) and manufactured by PPG Industries, comprising:
providing a stone or masonry substrate, where the substrate presents a substantially flat image-receiving surface or is otherwise shaped to accept an image, and where the image-receiving surface has a specular reflectivity suitable for accepting an image;
applying the PPG polymer to the substrate and curing the applied PPG polymer thereto;
providing a transferable sublimable ink image on an image transfer substrate suitable for transfer of the image to the stone or masonry substrate; and
applying the image transfer substrate carrying the transferable sublimable ink image to the cured PPG polymer and transferring the image into the cured PPG polymer via sublimation;
such that the transferable sublimable ink image migrates into and becomes substantially fused to the image-receiving surface of the substrate and embedded therein, the image-receiving surface of the substrate retaining a natural, matte appearance following transfer of the image, and the transferred sublimable ink image being durable and resistant to abrasion, wear and the effects of weather and UV radiation.

4. The method of claim 1 or claim 3, wherein the step of curing the polymer further comprises penetrating the polymer into the image-receiving surface of the substrate.

5. The method of claim 1 or claim 3, wherein the step of curing the polymer further comprises overlaying the polymer onto the image-receiving surface of the substrate and adhering it thereto.

6. The method of claim 1 or claim 3, wherein the step of transferring the image into the polymer further comprises receiving the sublimable ink image on the image-receiving surface of the substrate.

7. The method of claim 1 or claim 3, wherein the step of providing a stone or masonry substrate further comprises selecting a substrate from the group consisting of stone, brick, ceramic, concrete and asphalt.
